(19) United States
(12) Patent Application Publication
(10) Pub. No.: US 2026/0037405 A1
(43) Pub. Date: Feb. 5, 2026

(54) Supplemental Content Load Tuning

(71) Applicant: GOOGLE LLC, Mountain View, CA (US)

(72) Inventor: Saksham Banga, Mountain View, CA (US)

(21) Appl. No.: 18/795,030

(22) Filed: Aug. 5, 2024

(51) Int. Cl. G06F 11/34; H04L 41/12

(52) U.S. Cl. CPC G06F 11/3433; H04L 41/12

(57) ABSTRACT

A method of applying load configurations, for use in presenting supplemental content with streaming content, includes obtaining a slice configuration specifying (i) values of one or more slice parameters that define a particular streaming context and (ii) values of one or more load parameters that control supplemental content loads for streaming recipients. The method also includes identifying, from among a plurality of streaming instances provided by a streaming platform, streaming instances that match the particular streaming context, setting, for each of the identified streaming instances, the one or more load parameters to the specified values of the one or more load parameters, and determining one or more performance metrics by monitoring events associated with the identified streaming instances.

### FIELD OF TECHNOLOGY

The present disclosure relates to the provision of supplemental content (e.g., digital advertisements) within streamed content and, more specifically, to procedures for tuning the load (e.g., amount, frequency, etc.) of supplemental content within streamed content.

### BACKGROUND

The background description provided herein is for the purpose of generally presenting the context of the disclosure. Work of the presently named inventor(s), to the extent it is described in this background section, as well as aspects of the description that may not otherwise qualify as prior art at the time of filing, are neither expressly nor impliedly admitted as prior art against the present disclosure.

Streaming platforms typically insert additional, supplemental content into the primary (streamed video) content accessed by viewers. For example, streaming platforms may communicate with an ad server in order to retrieve and present video advertisements, which are then inserted before the streamed content (as “pre-roll” ads) and/or during breaks/pauses of the streamed content (as “mid-roll” ads). Such an arrangement can be mutually beneficial to both the provider (e.g., creator) of the streamed/primary content and the advertiser, e.g., with the former receiving revenue from the latter and the latter receiving valuable marketing exposure. An intermediary (e.g., ad server) provides the service of matching the digital advertisements to particular streaming instances (i.e., presentation of the primary content to particular users at particular times), which ultimately benefits both parties.

One important consideration in providing supplemental content is balancing the load (e.g., frequency, amount, and/or length) of the supplemental content provided to any given user. In the digital advertising context, for example, both primary and supplemental content providers can generally benefit from a higher load of digital advertisements, but primary content providers can lose some of their audience if digital advertisements are shown too frequently (or for too long a time period, etc.) during the primary/streamed content. The best load parameters (e.g., number of ads per break, frequency of ad breaks, etc.) may be those that jointly optimize a set of sometimes-conflicting performance metrics, such as impression metrics, click-through rates, revenue generated by various parties, numbers of viewers who abandon the primary/streamed content (e.g., due to annoyance with ads), and/or other metrics.

However, conventional systems fail to account for different load tolerances of different viewer cohorts, or other factors that might affect viewer load tolerance and/or risk tolerances of primary content providers/creators (e.g., tolerances for the risk of losing viewers). Thus, conventional systems fail to optimize or otherwise improve load tuning on a sufficiently granular level, resulting in inferior overall performance metrics. While experiments can theoretically be run to test different values of a particular load parameter, or to test a load parameter value for different cohorts (e.g., particular viewer device types), organizing such experiments is a very cumbersome and inefficient process, with each parameter change requiring modifications to hard-coded logic at multiple servers/services in a distributed system. This inefficiency, combined with the great diversity of streaming contexts (e.g., viewer device types, types of streaming content, etc.), makes individualized experiments or optimizations prohibitively expensive in terms of time and other resources. Moreover, it is very difficult to scale such load tuning (whether for experiments or when more widely implementing/adopting context-specific load parameter settings) in a manner that can encompass different (e.g., newly defined) load parameters and can focus on different streaming contexts. Accordingly, there is a need for systems and methods that provide load tuning in an efficient and scalable manner.

### SUMMARY

In the disclosed techniques, a computing system obtains a slice configuration, which may be manually and/or automatically generated. The slice configuration specifies values of slice parameters that define a particular streaming context, and values of load parameters that control supplemental content loads for streaming recipients. The computing system then identifies streaming instances that match the particular streaming context and, for each identified streaming instance, sets the load parameters to the specified values. The computing system monitors events associated with the identified streaming instances to determine one or more performance metrics. Such a method can provide a more granular and context-specific tuning of supplemental content loads, which in turn improves overall performance as reflected by measurable metrics (e.g., relating to supplemental content impressions or click rates, streaming content viewer retention rates, etc.).

Moreover, the disclosed techniques provide more scalable and efficient optimization, e.g., across an increasing diversity of streaming contexts, and/or an increasing number of available load tuning parameters. For example, in some implementations, a slice-based load tuning controller obtains the slice configuration and acts as a centralized entity by communicating with one or more request filters to enable the request filter(s) to identify the streaming instances to which the load parameter value(s) are to be applied, thereby obviating the need to modify the hard-coded logic at the request filter(s) on a case-by-case basis. The slice-based load tuning controller may also communicate with (e.g., act as a source of truth for) other entities. For example, the slice-based load tuning controller may communicate load parameter values to downstream supplemental content selection servers, which can then consider those values when selecting supplemental content to insert into the streamed video, thereby obviating the need to modify the hard-coded logic at the supplemental content selection servers on a case-by-case basis.

Further still, in some implementations, the computing system can discover optimal or otherwise improved load parameter settings by performing load tuning in an iterative, automated manner. For example, the computing system may iteratively generate new slice configurations that, for a given streaming context, traverse a range of load parameter values/settings, and monitor the performance for each value/setting or each combination of values/settings. Based on the monitored performance across iterations, the computing system may select a particular load parameter value or set of values having the best performance metric(s). Moreover, in some implementations, the computing system can determine the streaming context for the slice configuration(s), e.g., by using a machine learning model to identify a suitable streaming recipient cohort for the streaming context (e.g., to generate slice parameters likely to be associated with streaming recipients having similar supplemental content load tolerances, etc.).

### BRIEF DESCRIPTION OF THE DRAWINGS

FIG. 1 is a block diagram of an example system in which the disclosed techniques for supplemental content load tuning can be implemented.

FIG. 2 is a block diagram of an example system architecture that may be used in the system of FIG. 1.

FIG. 3 is a block diagram of an example slice-based load tuning controller that may be used in the system architecture of FIG. 2.

FIG. 4 depicts an example information resource configured to display streaming content and supplemental content.

FIG. 5 depicts an example process for iteratively conducting load tuning experiments.

FIG. 6 is a flow diagram of an example method for use in presenting supplemental content with streaming content.

### DETAILED DESCRIPTION OF THE DRAWINGS

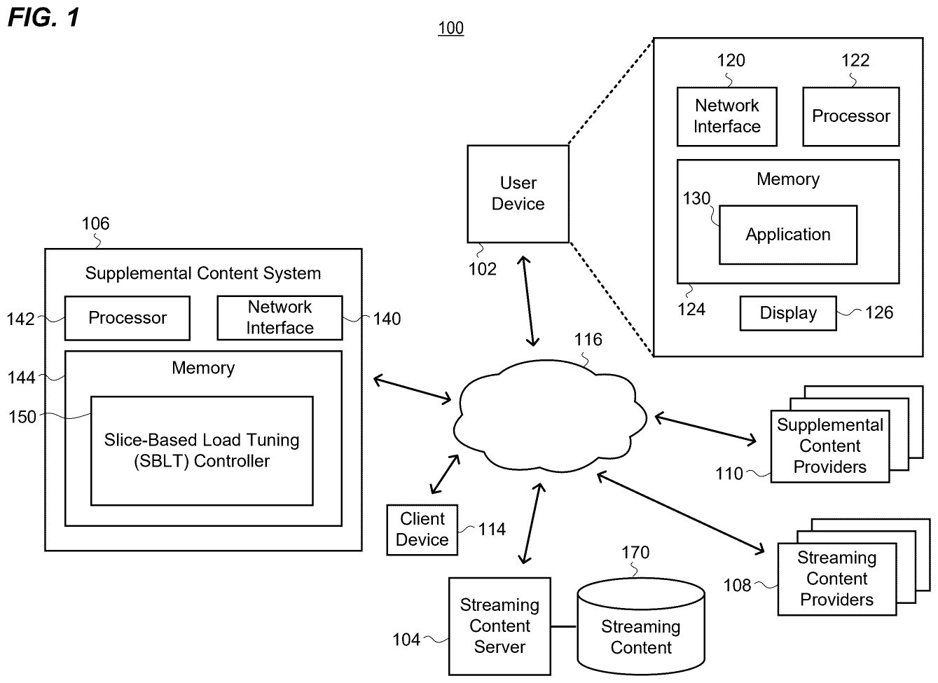

FIG. 1 illustrates an example system 100 in which techniques of the present disclosure can be implemented. The example system 100 includes a user device 102, a streaming content server 104, a supplemental content system 106, a number of streaming content providers 108, a number of supplemental content providers 110, and a client device 114, some or all of which may be remote from each other and communicatively coupled via a network 116. The communicative/network connections shown in FIG. 1 for streaming content providers 108 and supplemental content providers 110 represent communicative/network connections with computing systems, devices, processors, etc., that are associated with the streaming content providers 108 and supplemental content providers 110, respectively.

The network 116 may be a single communication network (e.g., the Internet), and in some implementations also includes one or more additional networks. As just one specific example, the network 116 may include a cellular network, the Internet, and a server-side local area network (LAN). While FIG. 1 shows only a single user device 102, it is understood that the system 100 may include any number (e.g., thousands or millions) of devices that are similar to user device 102 and operate in a manner similar to user device 102 as described herein. Similarly, while FIG. 1 shows only a single client device 114, it is understood that the system 100 may include any number (e.g., one, two, five, ten, etc.) of devices that are similar to client device 114 and operate in a manner similar to client device 114 as described herein. Moreover, in FIG. 1 and throughout this disclosure, a “system,” “server,” or “device” can be a single computing device or multiple computing devices (e.g., a set of two or more co-located or remotely distributed servers).

Generally, a user can operate user device 102 to access streamed digital content served by streaming content server 104. For example, streaming content server 104 may be the server of a video sharing platform such as YouTube®, and the streaming digital content may be any live, on-demand, or other type of video content that may or may not include associated audio content.

Some or all of the streaming content provided by streaming content server 104 may be sourced (e.g., created) by streaming content providers 108. For example, streaming content providers 108 may create accounts on a platform supported by streaming content server 104 and post their original video content on channels associated with those accounts. Users of user devices such as user device 102 can then access the platform to view live or earlier-created streaming content (e.g., by the user searching for specific content, by the user subscribing to a channel of a particular streaming content provider 108, by streaming content server 104 pushing specific content to specific users, and/or via any other suitable techniques).

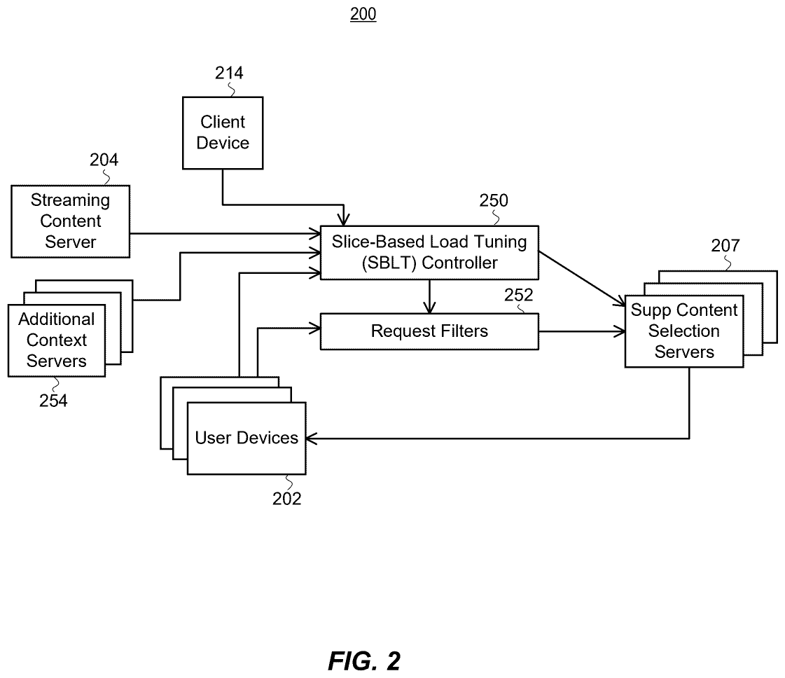

Supplemental content system 106 generally determines appropriate supplemental content loads for particular streaming instances (i.e., for particular users receiving particular primary/streamed content at particular times via particular devices and/or applications), and selects and/or provides particular supplemental content items to supplement the streamed content served to particular users in accordance with the determined supplemental content loads. As discussed further below (e.g., in connection with FIG. 2), supplemental content system 106 may include any suitable number of distinct servers that perform different operations (e.g., a first server that determines supplemental content loads for particular streaming instances, and other servers that select particular content items to be inserted as “mid-roll” advertisements at breakpoints in primary streamed content (video) in accordance with those determined loads). In other implementations, however, supplemental content system 106 is a single server.

In some implementations, the supplemental content discussed herein is stored in database 170. Alternatively, the supplemental content may be stored in a database maintained by supplemental content system 106, and/or in another suitable location or database. The supplemental content generally includes content created by, and/or otherwise associated with, supplemental content providers 110. For example, supplemental content items may include short video advertisements that, when selected (e.g., clicked upon) by users (e.g., a user of user device 102), direct the users to landing pages (e.g., pages for purchasing advertised products) of respective ones of the supplemental content providers 108 that are associated with the selected advertisements.

The system 100 may serve supplemental content items to users of user devices (e.g., user device 102) in different ways, depending on the implementation. In some implementations, for example, when streaming content server 104 is streaming content to user device 102 and reaches (or is about to reach) a breakpoint indicator in the video content, streaming content server 104 sends a request for supplemental content to supplemental content system 106. In response, supplemental content system 106 provides a “pod” of one or more supplemental content items (e.g., a pod of digital advertisement(s)). In particular, supplemental content system 106 may select supplemental content item(s) for the pod, and send the selected supplemental content item(s) (or identifiers of the supplemental content item(s)) to streaming content server 104. Streaming content server 104 may then receive or retrieve the supplemental content item(s) of the pod and forward the supplemental content item(s) to the user device 102 for presentation to the user. When the supplemental content item(s) have played (and/or been skipped by the user, in some implementations), the primary/streamed content resumes where it had left off.

Other arrangements are also possible. In some implementations, for example, when user device 102 is receiving streamed video content from streaming content server 104 and reaches (or is about to reach) a breakpoint indicator in the video content, user device 102 sends a request for supplemental content to streaming content server 104. In response, streaming content server 104 may send supplemental content system 106 a request for a supplemental content pod, and supplemental content system 106 may respond by selecting supplemental content item(s) for the pod and sending the selected supplemental content item(s) (or identifiers of the supplemental content item(s)) to streaming content server 104. Streaming content server 104 may then receive or retrieve the supplemental content item(s) of the pod and forward the supplemental content item(s) to the user device 102 for presentation to the user. When the supplemental content item(s) have played (and/or been skipped by the user, in some implementations), the primary/streamed content resumes where it had left off.

In yet another example, the user device 102 may directly request supplemental content from the supplemental content system 106. Other arrangements are also possible. In one alternative implementation, the operations of streaming content server 104 and supplemental content system 106 are provided by a single server or system.

As noted above, in addition to selecting specific supplemental content items to accompany primary content being streamed to users, supplemental content system 106 controls the load of supplemental content for users. Supplemental content “load” generally refers to the amount and/or timing of supplemental content presented to a user, irrespective of the substance or nature of the supplemental content itself, and irrespective of the substance or nature of the primary/streamed content into which the supplemental content is inserted. For example, the supplemental content load may be expressed as a function of the number of supplemental content items presented to a user at a given breakpoint (i.e., within a given supplemental content pod) or in a given time window/duration, the frequency at which supplemental content items are presented to a user, the fraction or percentage of content that is supplemental content rather than primary/streamed content, the amount of time until a first supplemental content item is presented to a user (e.g., depending on whether supplemental content breaks in live-streamed content are synchronized or not synchronized across multiple streaming recipients), and/or other quantities, variables, etc.

As noted above, it is generally important to balance the load (e.g., frequency, number, timing, length, etc.) of supplemental content items provided to any given user. In the digital advertising context, for example, both primary/streamed and supplemental content providers can generally benefit from a higher load of digital advertisements, but the primary content providers can lose some of their audience if digital advertisements are shown too frequently (or for too long a time period, etc.) during the primary/streamed content, or shown too early in the primary/streamed content, etc. The best load parameters (e.g., number of ads per break, frequency of ad breaks, etc.) may be those that jointly optimize a set of sometimes-conflicting performance metrics, such as impression metrics, click-through rates, revenue generated by various parties, numbers of viewers who abandon the primary/streamed content (e.g., due to annoyance with ads), and/or other suitable metrics. Accordingly, and as discussed further below, supplemental content system 106 may control the supplemental content load by applying one or more load parameter values in any given streaming instance, e.g., for purposes of running experiments on a subpopulation to see which load parameter values result in best overall performance, and/or for purposes of more broadly implementing validated or otherwise desired load parameter values (e.g., values already shown to provide good performance during the aforementioned experiments).

The user device 102 may be or include any stationary, mobile, or portable computing device with wired and/or wireless communication capability (e.g., a smartphone, a tablet computer, a laptop computer, a desktop computer, a smart wearable device such as smart glasses or a smart watch, a vehicle head unit computer, etc.). In the example implementation of FIG. 1, the user device 102 includes a network interface 120, a processor 122, memory 124, and a display 126. The processor 122 may be a single processor (e.g., a central processing unit (CPU)), or may include a set of processors (e.g., multiple CPUs, or one or more CPUs and one or more graphics processing units (GPUs)).

The memory 124 includes one or more computer-readable, non-transitory storage units or devices, which may include persistent (e.g., hard disk) and/or non-persistent memory components. The memory 124 stores instructions that are executable on the processor 122 to perform various operations, including the instructions of various software applications and the data generated and/or used by such applications. In the example implementation of FIG. 1, the memory 124 stores at least an application 130, which may be, for example, a web browser application (e.g., Chrome®), or a mobile application downloaded from an application store.

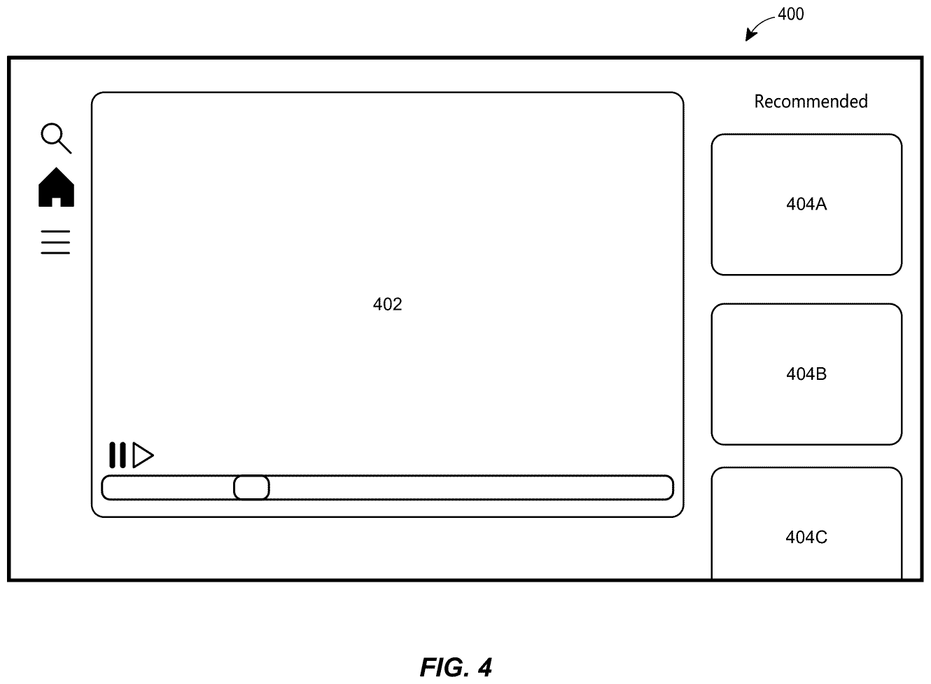

Generally, the application 130 is executed by the processor 122 to present information resources (i.e., user interfaces that include content) to the user of the user device 102 via the display 126, with at least one of those information resources including at least one content slot or other user interface component for dynamically presenting streaming content with inserted supplemental content. In an implementation where the application 130 is a web browsing application, for instance, an information resource may be a web page hosted by the streaming content server 104, with the browser causing the user device 102 to download HTML, scripts, and/or other code of the web page for presentation to a user via the display 126. As another example, the application 130 may be a video sharing application such as a YouTube® mobile application, and the information resource may be a user interface generated by the video sharing application and presented via the display 126. As yet another example, the application 130 may be a general-purpose video player application configured to access remote content from streaming content server 104. Some examples of an information resource that may be provided by application 130 are discussed below in connection with FIG. 4.

The display 126 includes hardware, firmware, and/or software configured to enable a user to view visual outputs of the user device 102, and may use any suitable display technology (e.g., LED, OLED, LCD, etc.). In some implementations, the display 126 is incorporated in a touchscreen having both display and manual input capabilities. Moreover, in some implementations where the user device 102 is a wearable device, the display 126 is a transparent viewing component (e.g., lenses of smart glasses) with integrated electronic components. For example, the display 126 may include micro-LED or OLED electronics embedded in lenses of smart glasses.

The network interface 120 includes hardware, firmware, and/or software configured to enable the user device 102 to exchange electronic data with at least the streaming content server 104 via the network 116. For example, the network interface 120 may include a cellular communication transceiver, a WiFi transceiver, and/or transceivers for one or more other wired and/or wireless communication technologies.

While FIG. 1 shows user device 102 as a single component communicating (via network 116) with the content server 104, in some implementations the subcomponents of user device 102 shown in FIG. 1 are instead divided among two or more user-side devices. As just one example, a pair of smart glasses may include the processor 122, the memory 124, and the display 126, while a smartphone may include another processing unit, another memory, another display, and the network interface 120. The smart glasses (or smart helmet, etc.) may then communicate as needed with the smartphone (e.g., via Bluetooth) to enable the operations described herein.

The supplemental content system 106 includes a network interface 140, a processor 142, and memory 144. The network interface 140 includes hardware, firmware, and/or software configured to enable the supplemental content system 106 to exchange electronic data with the streaming content server 104 and/or user device 102 (and other, similar user devices) via the network 116. For example, the network interface 140 may include a wired or wireless router and a modem. The processor 142 may be a single processor or may include two or more processors.

The memory 144 is a computer-readable, non-transitory storage unit or device, or collection of co-located or distributed units/devices, that may include persistent and/or non-persistent memory components. The memory 144 stores the instructions of a slice-based load tuning (SBLT) controller 150, which may be executed by the processor 142. Generally, the SBLT controller 150 sets particular load parameters to particular values for application to particular streaming instances. As noted above, the term “streaming instance” refers to particular streamed content (e.g., a particular video) being streamed to a particular streaming recipient (e.g., user device 102 or a particular application thereof such as application 130) at a particular time. Thus, for example, a user viewing a particular on-demand video from streaming content server 104 at user device 102 at a first time would correspond to a first streaming instance, and the same user viewing the same on-demand video at user device 102 at a second, later time would correspond to a second, different streaming instance. As another example, a user viewing a particular on-demand video from streaming content server 104 at user device 102 at a particular time would correspond to a first streaming instance, and the same user viewing the same on-demand video at a different device (or via a different application, etc., at user device 102) at the same time would correspond to a second, different streaming instance.

A configuration, which is referred to herein as a “slice configuration,” identifies the streaming instances to which a particular set of load parameter values is to be applied (either directly by SBLT controller 150, or responsive to instructions from SBLT controller 150, depending on the implementation), as well as the load parameter values themselves. The slice configuration may be a configuration created and entered by a user, a configuration that supplemental content system 106 automatically generates, or a combination of both.

To enable the identification of streaming instances to which the slice configuration is to be applied, each slice configuration includes values of one or more slice parameters that define a particular streaming context. As used herein, a “streaming context” (or “slice”) can refer to any set of one or more slice parameters (streaming instance characteristics). For example, slice parameters may include a parameter indicating a streaming content category (e.g., “gaming”, “music”, etc.), a parameter indicating a streaming recipient device type (e.g., an operating system type such as Android or iOS, or a device form factor type such as mobile device or tablet device, etc.), a parameter indicating an association between a streaming recipient and a streaming content provider (e.g., whether the recipient is a follower of or a subscriber to the provider), a parameter indicating whether streaming content is original, a parameter indicating a streaming recipient geographical region (e.g., country), a parameter indicating whether streaming content is live, a parameter indicating a time or date range, and/or any other suitable parameter(s) that can help identify a streaming context. More generally, the slice parameters may relate to the primary/streamed content (and/or the creator/provider thereof), the streaming recipient (device and/or device user), the timing of the streaming, and so on.

In addition to the slice parameter value(s), each slice configuration includes values of one or more load parameters that control supplemental content loads for streaming recipients. More specifically, the slice parameter value(s) control supplemental content loads for streaming instances that match the streaming context defined by the slice parameter value(s) of the same slice configuration. For example, the load parameter(s) of a slice configuration may include a parameter that controls how many supplemental content items are presented at streaming content breakpoints (e.g., within a single pod), a parameter that controls how much time passes between streaming content breakpoints, and/or a parameter that controls whether streaming content breakpoints are synchronized or not synchronized across different streaming recipients.

In some implementations, users of user devices (e.g., user device 102), the streaming content providers 108, and/or the supplemental content providers 110 hold accounts related to the services provided by the streaming content server 104 and/or the supplemental content system 106. For example, the streaming content providers 108 may create such accounts with the streaming content server 104 or the supplemental content system 106 in order to sell advertising opportunities for their live and/or on-demand videos. Such accounts may be associated with information such as entity name, preferences (e.g., a maximum amount of advertising to allow), and so on. As another example, the supplemental content providers 110 may create such accounts with the supplemental content system 106 in order to locate and/or purchase available advertising opportunities. Such accounts may be associated with information such as the entity name, preferences (e.g., brand control preferences), and so on. As yet another example, users of user devices (e.g., user device 102) may create such accounts with the streaming content server 104 in order to view streamed content. Such accounts may be associated with information such as the username, preferences, subscriptions to particular streaming content providers 108, and so on. Account data for any of the aforementioned account types may be stored in one or more databases, e.g., a database stored in memory 144 of supplemental content system 106 or a similar memory of streaming content server 104.

In operation, supplemental content system 106 (e.g., SBLT controller 150, alone or in conjunction with other components of system 106) obtains a given slice configuration. The slice configuration may be a configuration created and entered by a user of client device 114 which client device 114 then sends to supplemental content system 106, for example. In one such embodiment, SBLT controller 150 or another component of supplemental content system 106 provides a user interface and/or application programming interface (API) that client device 114 accesses or uses to provide the slice configuration.

Alternatively, SBLT controller 150 or another component of supplemental content system 106 may automatically generate the slice configuration. In some implementations, supplemental content system 106 uses (e.g., remotely accesses or locally implements) a machine learning model (e.g., a clustering model) to identify a particular cohort of streaming recipients based on one or more expected streaming recipient behaviors. For example, the machine learning model may identify cohorts (e.g., clusters or groups of users) that are likely to have similar tolerances for advertisements or other disruptions. In one such implementation, the machine learning model clusters users based on historical user activity such as how often the users tend to exit out of or otherwise abandon primary streamed content when presented with an advertisement or other supplemental content (if the users have previously agreed to share that information for such a purpose). The supplemental content system 106 can then generate value(s) of slice parameter(s) based on the identified cohort. As a more specific example, if the machine learning model clusters according to advertisement tolerance, and determines that viewers of “gaming” category content have tolerances similar to viewers of original content (regardless of the substance of the original content), then supplemental content system 106 may generate a slice configuration with slice parameter values indicating both the “gaming” category and original content. By using techniques of this sort, the supplemental content system 106 can advantageously reduce the number of experiments needed to fully test particular load parameter values, and thereby reduce the amount of time and processing resources required to set supplemental content loads in a manner that improves performance metrics.

After obtaining the slice configuration and during run-time operation, the supplemental content system 106 identifies, from among a plurality of streaming instances provided by the streaming content server 104 over time, streaming instances that match the streaming context defined by the slice parameter value(s) of the slice configuration. To that end, the supplemental content system 106 may gather context information from one or more sources, and compare the context information to the slice parameter value(s) as needed (i.e., depending on which slice parameter(s) is/are represented by the slice parameter(s) of the slice configuration). If the slice configuration includes the value “US” for a slice parameter indicative of geographic region, for example, the supplemental content system 106 may query location servers (or otherwise collect information from such servers) to determine whether streaming instances correspond to (e.g., are directed to recipients in) the United States of America. As another example, if the slice configuration includes the value “original” for a slice parameter indicative of whether primary/streamed content is original content, the supplemental content system 106 may query the streaming content server 104 (or otherwise receive information from server 104) to determine whether streaming instances correspond to original content.

For each of the identified/matching streaming instances, and in real-time as each the streaming instance is occurring or about to occur, the supplemental content system 106 sets one or more load parameters to the value(s) specified in the slice configuration. As discussed further in connection with FIG. 2, this may involve the SBLT controller 150 informing one or more other devices, entities, or modules that the load parameter value(s) are to be applied to the streaming instances. It is understood that the various streaming instances so identified need not be concurrent and may take place over some arbitrary time window (e.g., hours, days, weeks, etc.). In some implementations, the supplemental content system 106 also monitors events associated with the identified/matching streaming instances to assess the resulting performance (i.e., by determining one or more performance metrics). For example, the supplemental content system 106 may determine and/or collect an impression metric (e.g., with the monitored events including supplemental content items being presented to streaming recipients), an abandonment metric (e.g., with the monitored events including streaming content being terminated by streaming recipients), a metric indicative of viewing duration (e.g., with the monitored events including starting points and stopping points for viewing streaming content), a metric indicative of revenue (e.g., with the monitored events including revenue or spend amounts associated with supplemental content items), and/or other suitable metrics.

FIG. 2 is a block diagram of an example system architecture 200 that may be used in the system 100 of FIG. 1. The example system architecture 200 includes user devices 202, a streaming content server 204, a number of supplemental content selection servers 207, a client device 214, an SBLT controller 250, a number of request filters 252, and a number of additional context servers 254.

The user devices 202 may each be similar to user device 102, and streaming content server 204, client device 214, and SBLT controller 250 may be the same as streaming content server 104, client device 114, and SBLT controller 150, respectively. Moreover, in some implementations, the SBLT controller 150 is stored in the memory of a first server of supplemental content system 106 while supplemental content selection servers 207 are other, remotely located servers of supplemental content system 106.

Each of supplemental content selection servers 207 is generally configured to select specific supplemental content items for presentation to specific user devices of user devices 202 during specific streaming instances. Supplemental content selection servers 207 may select the supplemental content items based on any suitable factor(s), depending on the implementation. In some implementations, for example, supplemental content selection servers 207 selects supplemental content items (e.g., video advertisements or other short videos) based on the content of the primary streamed content being viewed by a user device user. As a more specific example, supplemental content selection server 207 may select a supplemental content item by calculating relevance scores (e.g., using a machine learning model) indicative of relevance of a plurality of supplemental content items to the primary/streamed content, and possibly other factors as well (e.g., keyword bid amounts for auctions implemented by supplemental content selection servers 207, etc.). As another example, supplemental content selection servers 207 may select supplemental content items based on user information, such as the geographical regions of users, preferences of users, and so on. In some implementations, each of supplemental content selection servers 207 is associated with (e.g., serves and/or is located within) a different geographical region.

Request filters 252 are generally configured to receive and process requests for supplemental content (e.g., from user devices 202 or streaming content server 204, depending on the implementation). The request filters 252 may be responsible for a number of enforcement operations, such as enforcing a particular supplemental content pod depth, blocking certain supplemental content requests, etc. The request filters 252 may collectively be implemented by one or more processors of processor 142 that are separate from one or more processors of processor 142 that implement SBLT controller 250.

For any given supplemental content request, SBLT controller 250 obtains context-relevant information from the streaming content server 204, one or more of the additional context servers 254, and/or a respective one of the user devices 202 (i.e., from the user device to which supplemental content is to be delivered). For example, SBLT controller 250 may receive, from streaming content server 204, data indicating the category of content being streamed by streaming content server 204, data indicating whether such content is original, data indicating whether such content is live content, data indicating the duration of such content, and/or other data/information that may help define the context of a particular streaming instance. Additionally or alternatively, SBLT controller 250 may receive, from one of user devices 202, data indicating the type of user device (e.g., operating system, form factor, etc.) and/or other relevant information that the user has agreed to share for that purpose.

The additional context servers 254 each contain one or more processors, and may be servers that, in the course of providing particular services (e.g., positioning services) generate or otherwise provide any data/information that can be used by SBLT controller 250 to identify a streaming context as specified by a slice configuration. For example, if a slice configuration includes a geographic region value, the additional context servers 254 may include a location server that tracks locations of user devices 202, if the users of user devices 202 have agreed that their locations can be used for such a purpose.

In some implementations, the request filters 252 are implemented by one or more servers that are remotely located relative to the servers 204, 207, and 254, and also remotely located relative to a server implementing the SBLT controller 250. In an alternative implementation, the request filters 252 are implemented by the same server that implements the SBLT controller 250.

In operation, a user of client device 214 enters parameter values for one or more slice configurations, with each slice configuration including both values for one or more slice parameters and values for one or more load parameters as discussed above. The client device 214 then transmits the entered slice configuration to the SBLT controller 250. In other implementations, as discussed elsewhere herein, the slice configuration is generated in an automated manner.

After the SBLT controller 250 obtains the slice configuration(s), and in real-time as streaming content server 204 provides streaming instances to the user devices 202, SBLT controller 250 processes the streaming context data discussed above in order to identify, within some universe of streaming instances (for all users/user devices, or a particular cohort therein), which streaming instances match at least one slice configuration (e.g., within a slice configuration file). For each matching streaming instance, SBLT controller 250 communicates with one or more of the request filters 252 to cause the request filters 252 to respect (i.e., enforce or otherwise operate in accordance with) the load parameter value(s) of the corresponding slice configuration.

The SBLT controller 250 may also communicate with the supplemental content selection servers 207 to cause the supplemental content selection servers 207 to select, for matching streaming instances, supplemental content items in accordance with the load parameter value(s) of the slice configuration. For example, if the SBLT controller 250 informs one of the supplemental content selection servers 207 that no more than three supplemental content items (e.g., three video advertisements) are to be inserted at a single breakpoint of primary/streamed content in a particular streaming instance, the receiving one of the supplemental content selection servers 207 may in response select three and only three supplemental content items for a supplemental content pod for the user device associated with that streaming instance.

Also in real-time as streaming content server 204 provides streaming instances to user devices, one or more of the supplemental content selection servers 207 select specific supplemental content items to insert at breakpoints of primary/streamed content. In some implementations and/or scenarios, the supplemental content selection servers 207 select, for each such breakpoint, a pod of multiple supplemental content items. For a given streaming instance, a responsible one of the supplemental content selection servers 207 determines the number of supplemental content items to include in the pod, and/or the total duration of those supplemental content items, based on the load parameter value(s). For example, a load parameter value may itself be a number of supplemental content items per breakpoint/pod, or may be a maximum time duration that effectively limits the number of supplemental content items per breakpoint/pod, etc.

After the responsible one of supplemental content selection servers 207 selects the supplemental content items (e.g., video advertisements) for a given pod of a given (matching) streaming instance, that server 207 provides the content items of the pod to the respective one of user devices 202. The server 207 may directly send pods to user devices 202, or may send links that user devices 202 can use to access the content items of the pods, etc., depending on the implementation. Some examples of how user devices 202 may present supplemental content of a pod along with primary/streamed content are discussed below in connection with FIG. 4.

Because the request filters 252 and the supplemental content selection servers 207 are subservient to the slice configuration applied by SBLT controller 250, supplemental content loads can be tuned without the need to modify the hard-coded logic at the supplemental content selection servers 207 and/or the request filters 252 each time a new streaming context and/or a new set of load parameter values is to be applied (e.g., applied as a test/experiment, or applied/implemented as a default going forward). Thus, the approach of FIG. 2 provides more scalable and more efficient optimization, e.g., across an increasing diversity of streaming contexts, and/or an increasing number of available load tuning parameters.

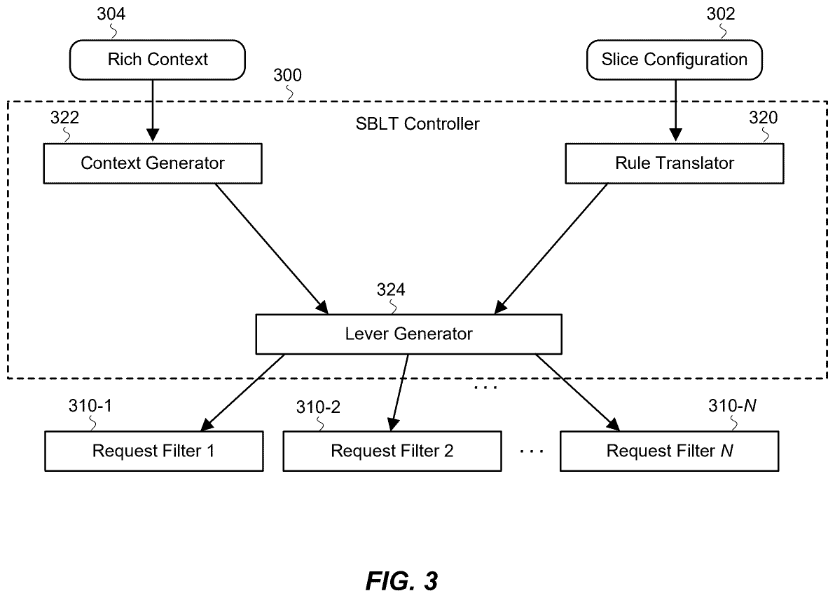

FIG. 3 is a block diagram of an example SBLT controller 300 that may be used in the system architecture 200 of FIG. 2. The SBLT controller 300 may be used as the SBLT controller 150 and/or the SBLT controller 250 of FIG. 2, for example.

As seen in FIG. 3, the SBLT controller 300 accepts as input both slice configuration data 302 and rich context data 304. The slice configuration data 302 may be, for example, data representing one or more user-prepared/entered slice configurations (e.g., received from client device 214) and/or data representing one or more automatically generated slice configurations (e.g., generated by SBLT controller 300 or another controller, module, or server using a machine learning model as described herein). The rich context data 304 can include any data associated with particular streaming instances (e.g., streaming video category, geographic region, time of day, subscriber status, etc.). SBLT controller 300 may receive the slice configuration data 302 offline, and receive the rich context data 304 during run-time operation as supplemental content requests are received by supplemental content system 106.

A rule translator 320 of the SBLT controller 300 processes the slice configuration data 302, and translates/converts the slice configuration data 302 into one or more programmatic rules understood by a lever generator 324 of the SBLT controller 300. A context generator 322 of the SBLT controller 300 identifies/extracts, from the rich context data 304 and for each streaming instance, those specific context fields that the SBLT controller 300 needs (or may potentially need) to identify whether the streaming instance matches the slice parameter values of one or more particular slice configurations. Using the extracted context data from context generator 322 and the rules produced by rule translator 320, a lever generator 324 iterates through the slice configurations (if more than one slice configuration is present, e.g., in a configuration file), and determines whether each slice configuration matches the context associated with a given streaming instance.

For matching streaming instances, the lever generator 324 generates control data and sends the control data to one or more of N request filters 310-1 through 310-N, where N is any suitable integer greater than zero. The control data may cause the request filter(s) 310 to enforce the load parameter value(s) indicated by the rule corresponding to the applicable slice configuration. The request filter(s) 310 may be the request filters 252 of FIG. 2, for example.

FIG. 4 depicts an example information resource 400 configured to display streaming content and supplemental content. The information resource 400 may be provided by application 130 of user device 102, or by a similar application and/or user device. For example, the information resource 400 may be a web page accessed by a web browser application, or a page of a dedicated mobile application. FIG. 4 merely provides one example of how supplemental content may be presented to users along with primary/streamed content. It is understood that, in other implementations, supplemental and/or primary/streamed content may be provided to users in other suitable ways.

In the example of FIG. 4, and with specific reference to the components of FIG. 1, the information resource 400 includes a content slot 402 in which the primary/streamed content (video) provided by streaming content server 104 is visually presented/played by application 130. At each of one or more breakpoints in the primary/streamed video (or, in some implementations, before the primary/streamed video), the application 130 temporarily ceases to present the primary/streamed video, and instead plays/presents supplemental content items (videos) of a supplemental content pod in content slot 402. When the supplemental content items of the pod are complete (or, in some implementations and scenarios, skipped by the user), the content slot 402 returns to showing the primary/streamed video (e.g., at the point where it was paused, or at the current time if live content). In the example of FIG. 4, other videos recommended by streaming content server 104 or 204 are visually presented by application 130 (e.g., as a still, single frame, or an introductory image, etc.) in content slots 404 (in this example, 404A-content slots 404C). In other implementations, there are more or fewer than three content slots 404, or content slots 404 are omitted entirely.

As another example, in one alternative implementation, the application 130 pauses the primary/streamed video in content slot 402 on a single frame when a breakpoint is reached, and overlays the supplemental content items on a portion of the frozen frame. Other arrangements for presenting supplemental content are also possible.

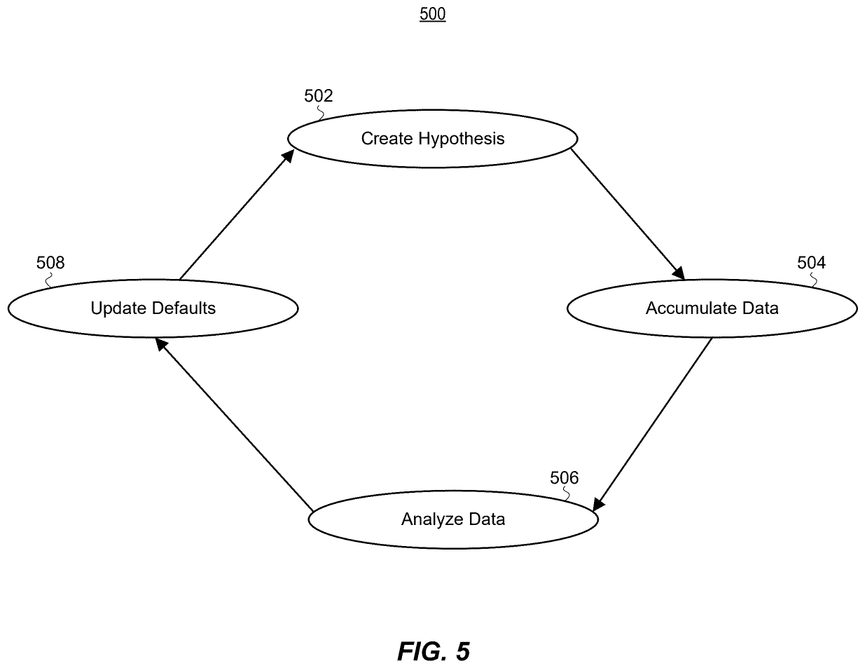

FIG. 5 depicts an example process 500 for iteratively conducting load tuning experiments. The process 500 may be implemented by (and/or implemented using) components of system 100 of FIG. 1, for example.

At stage 502 of process 500, a hypothesis as to how supplemental loads may be improved (i.e., to provide better performance) is created. The hypothesis may be created by a human user of client device 114, in some implementations. Also at stage 502, the user may enter the parameters/values of a slice configuration that would cause the hypothesis to be tested. As an example, a user may hypothesize that individuals watching streamed gaming videos in the United States would typically be willing to tolerate three mid-roll advertisements per break/pod, rather than a current lower number (one or two). To test this, the user of client device 114 or 214 may enter a slice configuration with
{video_category=GAMING; viewer_country=US}
{ad_pod_depth=3},
   where “video_category” and “viewer_country” are slice parameters and “ad_pod_depth” is a load parameter.

As another example, a user may hypothesize that individuals watching live-streamed content from a content creator on a channel to which the individuals subscribe would typically be more willing to watch (and possibly interact with) mid-roll advertisements, rather than exit out of the live-streamed content, if ad breaks occurred every eight minutes instead of every five minutes. To test this, the user of client device 114 may enter a slice configuration with
{live_original=YES; subscriber=YES}
{ad_frequency=8},
   where “live_original” and “subscriber” are slice parameters and “ad_frequency” is a load parameter.

In some implementations, the user of client device 114 can enter the slice configuration without writing any code (other than entering parameters and values using the simple language of the slice configurations), and without any code being deployed to/within components outside of the SBLT controller 150 or 250 (e.g., without any code being deployed to request filters 252, supplemental content selection servers 207, additional context servers 254, etc.).

At stage 504, the supplemental content system 106 accumulates data indicating the results of the slice configuration (i.e., results from the load parameter value(s) being applied to the matching streaming instances). Stage 504 may include supplemental content system 106 (e.g., SBLT controller 150) receiving performance data from one or more sources, such as user devices 202 or 102, supplemental content selection servers 207, streaming content server 204 or 104, supplemental content providers 110, streaming content providers 108, and/or other sources. For example, supplemental content selection servers 207 may provide data indicative of which supplemental content items were presented at which user devices (e.g., data indicative of impression events). As another example, in an implementation where supplemental content items are digital advertisements that direct users to respective landing pages (when a user clicks or otherwise selects the digital advertisement), supplemental content providers 110 may provide data indicative of which supplemental content items were selected (e.g., data indicative of click-through events) and/or data indicative of which supplemental content item impressions or selections resulted in sales (e.g., data indicative of conversion events). As yet another example, streaming content server 104 or 204 may provide data indicative of the timing of users exiting out of, or otherwise terminating or ceasing to watch, the primary/streamed video content (e.g., data indicative of abandonment events).

The length of the experiment may depend on the amount of data to be accumulated at stage 504. Generally, stage 504 may last long enough to ensure that the supplemental content system 106 collects a statistically significant amount of data. This duration is generally longer if the experiment is applied only to a smaller cohort (e.g., 5% of all users within a larger cohort/general population). The duration can also be proportional to the percentage of streaming instances that match the streaming context defined by the slice configuration, such that the duration is slice-dependent. The desired amount of data may be reflected as a minimum number of impressions, for example, or in terms of any other suitable metric.

At stage 506, supplemental content system 106 (e.g., SBLT controller 150) analyzes the data collected at stage 504 to determine the resulting performance of the experiment, as defined by any suitable metric(s). In different implementations, stage 506 may occur in parallel with stage 504 (as data is collected), after stage 504, or partially in parallel with and partially after stage 504. Stage 506 may include using the data collected at stage 504 to calculate one or more metrics such as impression rates (or “opportunity” rates), abandonment rates, click-through rates, revenue numbers (e.g., for advertisers, in some implementations where supplemental content items are advertisements), average watch times (e.g., average watch times for the supplemental content items and/or for the primary/streamed content), and/or other suitable performance metrics.

In some implementations, stage 506 includes computing an overall metric based on individual performance metrics that are relevant to different entities with different interests (e.g., an abandonment rate relevant to content creators, an impression or click-through rate relevant to advertisers, and a revenue or spend amount relevant to content creators as well as a provider of an advertising platform), and also based on respective weights for those individual performance metrics.

At stage 508, if the experiment is successful (e.g., if performance as determined at stage 506 is deemed to be sufficient), the SBLT controller 150 may apply the slice configuration of the experiment as a default configuration/setting. For example, the experiment of stages 502 through 506 may be conducted on a cohort consisting of only 5% of the general population (i.e., such that the SBLT controller 150 only applies the load parameter values to streaming instances that are both within the 5% cohort and match the streaming context of the slice configuration), while stage 508 may include updating a configuration file such that SBLT controller 150 applies the settings to a larger cohort (e.g., 100% of the general population). If the experiment is deemed unsuccessful, the slice configuration may instead be discarded or otherwise not applied as a default setting. Stage 508 may include manual review/confirmation/input, e.g., by a user of client device 114. The process 500 may be iterated as much as desired, by continuing to create new hypotheses (stage 502) based on earlier results, for example. In some implementations, stage 508 includes the SBLT controller 150 determining when a threshold amount of data has been collected (from stage 504) and, in response, causing a display (e.g., at client device 114) to present an indication that the experiment is acceptable or complete.

In some implementations, the process 500 includes the SBLT controller 150 iteratively moving through different slice configurations to test out a range of slice and/or load parameter values. For example, a user of client device 114 may enter a range of load parameter values, and an associated stride/step size, to test for a specific slice configuration. The SBLT controller 150 may then iteratively apply the slice configurations starting at one end of the load parameter value range and moving through (at the specified stride/step size) to the other end of the range, with stages 504 and 506 occurring for each step.

As another example, supplemental content system 106 (or another system) may execute or access a machine learning model (e.g., a trained neural network) that outputs data indicative of a specific streaming context, and SBLT controller 150 or another component may use that output data to generate slice parameters/values indicative of that streaming context. For example, the machine learning model may accept as input streaming context data (e.g., similar to rich context data 304) and corresponding performance data (e.g., similar to data accumulated at stage 504 and/or similar to outputs of data analysis at stage 506), and output data indicative of which streaming contexts tend to be associated with similar viewer tolerance levels for supplemental content. In some implementations, the machine learning model is a clustering model that clusters different streaming contexts (streaming recipients, etc.) based on supplemental content tolerance.

In some implementations, SBLT controller 150 applies a rule conflict resolution algorithm to determine which rules control in cases where a slice configuration file includes two or more slice configurations that (1) apply to the same streaming instance and (2) conflict with each other in some way. For example, a first slice configuration may specify that all users viewing original content in Canada should have an ad pod depth of three, while a second slice configuration may specify that all users viewing original gaming content should have an ad pod depth of two. For users viewing original gaming content in Canada, this results in two different pod depths being indicated for the same streaming instances.

In one such implementation, the rule conflict resolution algorithm gives priority to rules that were more recently added to the slice configuration file (e.g., as determined based on position within the slice configuration file, or as determined based on version data, etc.). Other algorithms are also possible. In some implementations, when a rule conflict exists, the SBLT controller 150 generates data (e.g., for storage in memory, or for presentation at client device 114 in an alert, etc.) indicating which rules were in conflict, and which rule was applied as a result of the conflict resolution algorithm. In some implementations, SBLT controller 150 generates such data in aggregate form (e.g., data indicating what percentage of streaming instances were subject to rules conflicts, etc.).

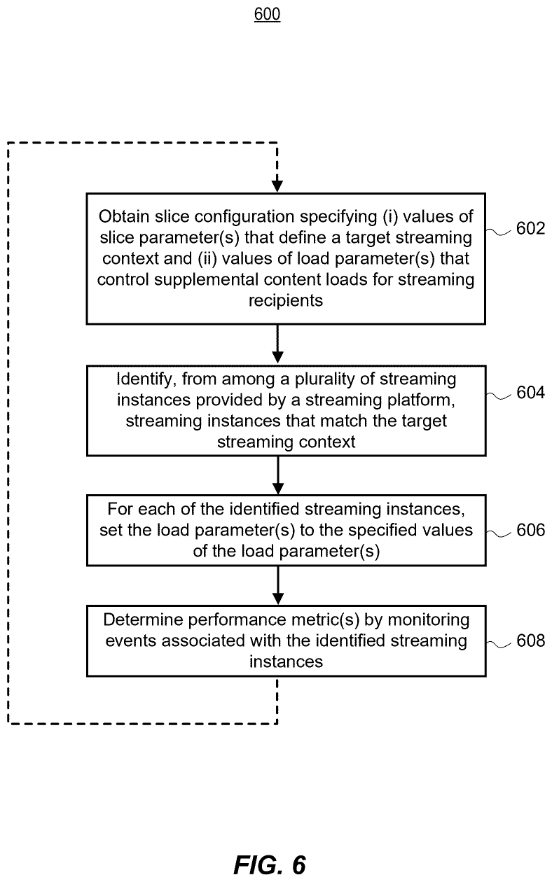

FIG. 6 is a flow diagram of an example method 600 for use in presenting supplemental content with streaming content. The method 600 may be implemented by supplemental content system 106 (e.g., SBLT controller 150) of FIG. 1, for example.

At block 602, a slice configuration is obtained. The slice configuration specifies values of one or more slice parameters that define a target streaming context, and also specifies values of one or more load parameters that control supplemental content loads for streaming recipients. The slice parameters may include, for example, a parameter indicating a streaming content category, a parameter indicating a streaming recipient device type, a parameter indicating an association between a streaming recipient and a streaming content provider, a parameter indicating whether streaming content is original, a parameter indicating a streaming recipient geographical region, and/or any other suitable parameter(s) that can help identify a streaming context. The load parameters may include, for example, a parameter that controls how many supplemental content items are presented at streaming content breakpoints, a parameter that controls how much time passes between streaming content breakpoints, a parameter that controls whether streaming content breakpoints are synchronized across different streaming recipients, and/or any other suitable parameter(s) that dictate the load (amount, frequency, etc.) of supplemental content.

At block 604, streaming instances that match the target streaming context are identified from among a plurality of streaming instances provided by a streaming platform (e.g., a platform supported by streaming content server 104). Block 604 may include, for example, receiving from a streaming platform (e.g., provided by streaming content server 104) a plurality of requests for supplemental content while the streaming platform provides the plurality of streaming instances, and determining whether streaming contexts associated with those requests match the particular streaming context. Block 604 may include receiving streaming context data from one or more sources, such as user devices 202, streaming content server 204, and/or additional context servers 254, for example.

At block 606, for each of the streaming instances identified at block 604, the load parameter(s) are set to the load parameter values specified in the slice configuration. In some implementations, block 606 includes causing one or more request filters (e.g., one or more of request filters 252 or 310) to operate in accordance with the specified values for the streaming instances that match the particular streaming context.

At block 608, one or more performance metrics are determined by monitoring events associated with the streaming instances identified at block 604. The performance metric(s) may include, for example, an impression metric (where the events include presenting supplemental content items to streaming recipients), an abandonment metric (where the events include terminations of streaming content by streaming recipients), a metric indicative of viewing duration (where the events include starting points and stopping points for viewing streaming content), a metric indicative of revenue (where the events include revenue or spend amounts associated with supplemental content items), and so on. In some implementations, block 608 includes determining when a threshold amount of data has been collected, and the method 600 includes an additional block in which, responsive to the threshold amount of data having been collected, a display (e.g., of client device 114) is caused to present an indication that an experiment associated with the slice configuration is acceptable or complete.

The method 600 may be repeated/iterated for multiple slice configurations. Moreover, in some implementations, the method 600 includes still other blocks not shown in FIG. 6. For example, the one or more performance metrics may include a plurality of performance metrics, and the method 600 may include an additional block in which an overall metric is computed based on those performance metrics and on a plurality of respective metric weights. As another example, the method 600 may include a first additional block in which the values of the one or more load parameters are received (e.g., by one or more of supplemental content selection servers 207 from SBLT controller 250), and a second additional block in which supplemental content is selected (e.g., by the same one or more of supplemental content selection servers 207) based in part on the load parameter value(s). As yet another example, the method 600 may include a first additional block in which the slice configuration is added to a default configuration file that controls supplemental content loads for a larger cohort of streaming recipients (i.e., a larger cohort than the cohort for which the matching streaming instances were initially identified), and/or a second additional block in which a conflict resolution algorithm is applied when two or more slice configurations of the default configuration file indicate different values of a same load parameter for a single streaming instance (e.g., assigning priority based on an order in which slice configurations were added to the default configuration file).

In some implementations, the techniques disclosed herein use artificial intelligence to facilitate supplemental content load tuning. Artificial intelligence (AI) is a segment of computer science that focuses on the creation of models that can perform tasks with little to no human intervention. Artificial intelligence systems can utilize, for example, machine learning, natural language processing, and computer vision. Machine learning, and its subsets, such as deep learning, focus on developing models that can infer outputs from data. The outputs can include, for example, predictions and/or classifications. Natural language processing focuses on analyzing and generating human language. Computer vision focuses on analyzing and interpreting images and videos. Artificial intelligence systems can include generative models that generate new content, such as images, videos, text, audio, and/or other content, in response to input prompts and/or based on other information.

Example machine-learned models include neural networks or other multi-layer non-linear models. Example neural networks include feed forward neural networks, deep neural networks, recurrent neural networks, and convolutional neural networks. Some example machine-learned models can leverage an attention mechanism such as self-attention. For example, some machine-learned models can include multi-headed self-attention models (e.g., transformer models).

The model(s) can be trained using various training or learning techniques. The training can implement supervised learning, unsupervised learning, reinforcement learning, etc. The training can use techniques such as, for example, backwards propagation of errors. For example, a loss function can be backpropagated through the model(s) to update one or more parameters of the model(s) (e.g., based on a gradient of the loss function). Various loss functions can be used such as mean squared error, likelihood loss, cross entropy loss, hinge loss, and/or various other loss functions. Gradient descent techniques can be used to iteratively update the parameters over a number of training iterations. A number of generalization techniques (e.g., weight decays, dropouts) can be used to improve the generalization capability of the models being trained.

The model(s) can be pre-trained before domain-specific alignment. For instance, a model can be pretrained over a general corpus of training data and fine-tuned on a more targeted corpus of training data. A model can be aligned using prompts that are designed to elicit domain-specific outputs. Prompts can be designed to include learned prompt values (e.g., soft prompts). The trained model(s) may be validated prior to their use using input data other than the training data, and may be further updated or refined during their use based on additional feedback/inputs.

In some implementations, the supplemental content system 106 (e.g., the SBLT controller 150 or another component) may use or access any one or more the machine learning models noted above to perform any one or more of the operations discussed herein in connection with machine learning. For example, the supplemental content system 106 may use one or more such machine learning models to identify a streaming context of interest as discussed above, and then generate slice parameters based on the identified streaming context.

Although the foregoing text sets forth a detailed description of numerous different aspects and implementations of the invention, it should be understood that the scope of the patent is defined by the words of the claims set forth at the end of this patent. The detailed description is to be construed as exemplary only and does not describe every possible implementation because describing every possible implementation would be impractical, if not impossible. Numerous alternative implementations could be implemented, using either current technology or technology developed after the filing date of this patent, which would still fall within the scope of the claims. The disclosure herein contemplates at least the following examples:

Example 1. A method of applying load configurations for use in presenting supplemental content with streaming content, the method comprising: obtaining, by one or more processors, a slice configuration specifying (i) values of one or more slice parameters that define a particular streaming context and (ii) values of one or more load parameters that control supplemental content loads for streaming recipients; identifying, by the one or more processors and from among a plurality of streaming instances provided by a streaming platform, streaming instances that match the particular streaming context; setting, by the one or more processors and for each of the identified streaming instances, the one or more load parameters to the specified values of the one or more load parameters; and determining, by the one or more processors, one or more performance metrics by monitoring events associated with the identified streaming instances.

Example 2. The method of example 1, wherein: the one or more processors includes a plurality of processors; obtaining the slice configuration and identifying the streaming instances that match the particular streaming context are performed by a slice-based load tuning controller implemented by a first subset of the plurality of processors; and setting the one or more load parameters to the specified values of the one or more load parameters includes the slice-based load tuning controller causing one or more request filters to operate in accordance with the specified values for the streaming instances that match the particular streaming context, the one or more request filters being collectively implemented by a second subset of the plurality of processors.

Example 3. The method of example 2, wherein identifying the streaming instances that match the particular streaming context includes receiving streaming context data from one or both of: a plurality of user devices associated with the plurality of streaming instances; and the streaming platform.

Example 4. The method of example 2 or 3, further comprising: receiving, by one or more supplemental content selection servers that collectively include a third subset of the plurality of processors, and from the slice-based load tuning controller, the values of the one or more load parameters; and selecting, by the one or more supplemental content selection servers, supplemental content based in part on the values of the one or more load parameters.

Example 5. The method of any one of examples 1-4, wherein the one or more load parameters include at least one of: a parameter that controls how many supplemental content items are presented at streaming content breakpoints; a parameter that controls how much time passes between streaming content breakpoints; or a parameter that controls whether streaming content breakpoints are synchronized across different streaming recipients.

Example 6. The method of any one of examples 1-5, wherein the one or more slice parameters include a parameter indicating a streaming content category.

Example 7. The method of any one of examples 1-6, wherein the one or more slice parameters include a parameter indicating a streaming recipient device type.

Example 8. The method of any one of examples 1-7, wherein the one or more slice parameters include a parameter indicating an association between a streaming recipient and a streaming content provider.

Example 9. The method of any one of examples 1-8, wherein the one or more slice parameters include one or both of: a parameter indicating whether streaming content is original; and a parameter indicating a streaming recipient geographical region.

Example 10. The method of any one of examples 1-9, wherein: the plurality of streaming instances includes a plurality of live streaming instances; and the one or more load parameters control supplemental video loads that occur for streaming recipients at streaming content breakpoints.

Example 11. The method of any one of examples 1-10, wherein at least one of: the one or more performance metrics include an impression metric and the events include resenting supplemental content items to streaming recipients; the one or more performance metrics include an abandonment metric and the events include terminations of streaming content by streaming recipients; the one or more performance metrics include a metric indicative of viewing duration and the events include starting points and stopping points for viewing streaming content; or the one or more performance metrics include a metric indicative of revenue and the events include spend amounts associated with supplemental content items.

Example 12. The method of any one of examples 1-11, wherein: the one or more performance metrics include a plurality of performance metrics; and the method further comprises computing an overall metric based on the plurality of performance metrics and a plurality of respective metric weights.

Example 13. The method of any one of examples 1-12, wherein identifying the streaming instances that match the particular streaming context includes: receiving, from the streaming platform and while the streaming platform provides the plurality of streaming instances, a plurality of requests for supplemental content; and determining whether streaming contexts associated with the plurality of requests match the particular streaming context.

Example 14. The method of example 13, wherein the plurality of streaming instances is associated with a cohort of streaming recipients within a larger cohort of streaming recipients, and wherein the method further comprises: adding, by the one or more processors and after determining the one or more performance metrics, the slice configuration to a default configuration file that controls supplemental content loads for the larger cohort of streaming recipients.

Example 15. The method of example 14, further comprising: applying, by the one or more processors, a conflict resolution algorithm when two or more slice configurations of the default configuration file indicate different values of a same load parameter for a single streaming instance.

Example 16. The method of example 15, wherein the conflict resolution algorithm determines which of a plurality of conflicting load parameter values to apply based on an ordering of slice configurations within the default configuration file.

Example 17. The method of example 16, wherein the conflict resolution algorithm determines which of a plurality of conflicting load parameter values to apply based on weights of slice configurations within the default configuration file.

Example 18. The method of any one of examples 1-17, wherein: determining the one or more performance metrics includes determining when a threshold amount of data has been collected; and the method further includes causing, by the one or more processors and responsive to the threshold amount of data having been collected, a display to present an indication that an experiment associated with the slice configuration is acceptable or complete.

Example 19. The method of any one of examples 1-18, wherein the slice configuration is a first slice configuration, wherein the values of the one or more load parameters are first values of the one or more load parameters, wherein the streaming instances are first streaming instances, wherein obtaining the slice configuration includes generating the first slice configuration, and wherein the method further comprises, after determining the one or more performance metrics: generating, by the one or more processors, a second slice configuration specifying second values of the one or more load parameters; identifying, by the one or more processors and from among an additional plurality of streaming instances provided by the streaming platform, second streaming instances that match the particular streaming context; setting, by the one or more processors and for each of the identified second streaming instances, the one or more load parameters to the specified second values of the one or more load parameters; and determining, by the one or more processors, one or more additional performance metrics by monitoring events associated with the identified second streaming instances.

Example 20. The method of example 19, wherein generating the second slice configuration includes generating the second values based on one or both of a stride parameter and a range parameter.

Example 21. The method of example 19, wherein generating the second slice configuration includes generating the second values based on the one or more performance metrics.

Example 22. The method of any one of examples 1-21, wherein: obtaining the slice configuration includes identifying, using a machine learning model, a cohort of streaming recipients based on one or more expected streaming recipient behaviors; and generating a value of at least one slice parameter of the one or more slice parameters based on the identified cohort.

Example 23. The method of example 22, wherein the machine learning model is a clustering model.

Example 24. A system comprising: one or more processors; and one or more non-transitory, machine-readable media storing instructions that, when executed by the one or more processors, cause the one or more processors to perform the method of any one of examples 1-23.

Example 25. One or more non-transitory, machine-readable media storing instructions that, when executed by one or more processors, cause the one or more processors to perform the method of any one of examples 1-23.

The following additional considerations apply to the foregoing discussion. Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter of the present disclosure.

Unless otherwise apparent from the context of use, reference in the present disclosure to a same set of “one or more processors” (or a same “plurality of processors,” etc.) performing multiple operations can encompass implementations in which performance of the operations is divided among the processor(s) in any suitable way. For example, “generating, by one or more processors, X; and generating, by the one or more processors, Y” can encompass: (1) implementations in which a first subset of the processors (e.g., in a first computing device) generates X and an entirely distinct, second subset of the processors (e.g., in a different, second computing device) independently generates Y; (2) implementations in which all of the processor(s) (e.g., one or multiple processors all in the same device, or multiple processors distributed among multiple devices) contribute to the generation of both X and Y; and (3) other variations.

Unless specifically stated otherwise, discussions in the present disclosure using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used in the present disclosure any reference to “one implementation” or “an implementation” means that a particular element, feature, structure, or characteristic described in connection with the implementation is included in at least one implementation or implementation. The appearances of the phrase “in one implementation” in various places in the specification are not necessarily all referring to the same implementation.

As used in the present disclosure, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

Upon reading this disclosure, those of skill in the art will appreciate still additional alternative structural and functional designs through the principles described herein. Thus, while particular implementations and applications have been illustrated and described, it is to be understood that the disclosed implementations are not limited to the precise construction and components disclosed in the present disclosure. Various modifications, changes and variations, which will be apparent to those skilled in the art, may be made in the arrangement, operation and details of the method and apparatus disclosed in the present disclosure without departing from the spirit and scope defined in the appended claims.

What is claimed is:

1. A method of applying load configurations for use in presenting supplemental content with streaming content, the method comprising:
obtaining, by one or more processors, a slice configuration specifying (i) values of one or more slice parameters that define a particular streaming context and (ii) values of one or more load parameters that control supplemental content loads for streaming recipients;
identifying, by the one or more processors and from among a plurality of streaming instances provided by a streaming platform, streaming instances that match the particular streaming context;
setting, by the one or more processors and for each of the identified streaming instances, the one or more load parameters to the specified values of the one or more load parameters; and
determining, by the one or more processors, one or more performance metrics by monitoring events associated with the identified streaming instances.

2. The method of claim 1, wherein:
the one or more processors includes a plurality of processors;
obtaining the slice configuration and identifying the streaming instances that match the particular streaming context are performed by a slice-based load tuning controller implemented by a first subset of the plurality of processors; and
setting the one or more load parameters to the specified values of the one or more load parameters includes the slice-based load tuning controller causing one or more request filters to operate in accordance with the specified values for the streaming instances that match the particular streaming context, the one or more request filters being collectively implemented by a second subset of the plurality of processors.

3. The method of claim 2, wherein identifying the streaming instances that match the particular streaming context includes receiving streaming context data from one or both of:
a plurality of user devices associated with the plurality of streaming instances; and
the streaming platform.

4. The method of claim 2, further comprising:
receiving, by one or more supplemental content selection servers that collectively include a third subset of the plurality of processors, and from the slice-based load tuning controller, the values of the one or more load parameters; and
selecting, by the one or more supplemental content selection servers, supplemental content based in part on the values of the one or more load parameters.

5. The method of claim 1, wherein the one or more load parameters include at least one of:
a parameter that controls how many supplemental content items are presented at streaming content breakpoints;
a parameter that controls how much time passes between streaming content breakpoints; or
a parameter that controls whether streaming content breakpoints are synchronized across different streaming recipients.

6. The method of claim 1, wherein the one or more slice parameters include at least one of:
a parameter indicating a streaming content category;
a parameter indicating a streaming recipient device type;
a parameter indicating an association between a streaming recipient and a streaming content provider;
a parameter indicating whether streaming content is original; or
a parameter indicating a streaming recipient geographical region.

7. The method of claim 1, wherein:
the plurality of streaming instances includes a plurality of live streaming instances; and
the one or more load parameters control supplemental video loads that occur for streaming recipients at streaming content breakpoints.

8. The method of claim 1, wherein at least one of:
the one or more performance metrics include an impression metric and the events include presenting supplemental content items to streaming recipients;
the one or more performance metrics include an abandonment metric and the events include terminations of streaming content by streaming recipients;
the one or more performance metrics include a metric indicative of viewing duration and the events include starting points and stopping points for viewing streaming content; or
the one or more performance metrics include a metric indicative of revenue and the events include spend amounts associated with supplemental content items.

9. The method of claim 1, wherein:
the one or more performance metrics include a plurality of performance metrics; and
the method further comprises computing an overall metric based on the plurality of performance metrics and a plurality of respective metric weights.

10. The method of claim 1, wherein identifying the streaming instances that match the particular streaming context includes:
receiving, from the streaming platform and while the streaming platform provides the plurality of streaming instances, a plurality of requests for supplemental content; and
determining whether streaming contexts associated with the plurality of requests match the particular streaming context.

11. The method of claim 10, wherein the plurality of streaming instances is associated with a cohort of streaming recipients within a larger cohort of streaming recipients, and wherein the method further comprises:
adding, by the one or more processors and after determining the one or more performance metrics, the slice configuration to a default configuration file that controls supplemental content loads for the larger cohort of streaming recipients.

12. The method of claim 11, further comprising:
applying, by the one or more processors, a conflict resolution algorithm when two or more slice configurations of the default configuration file indicate different values of a same load parameter for a single streaming instance, wherein the conflict resolution algorithm determines which of a plurality of conflicting load parameter values to apply based on an ordering of slice configurations within the default configuration file.

13. The method of claim 1, wherein the slice configuration is a first slice configuration, wherein the values of the one or more load parameters are first values of the one or more load parameters, wherein the streaming instances are first streaming instances, wherein obtaining the slice configuration includes generating the first slice configuration, and wherein the method further comprises, after determining the one or more performance metrics:
generating, by the one or more processors, a second slice configuration specifying second values of the one or more load parameters;
identifying, by the one or more processors and from among an additional plurality of streaming instances provided by the streaming platform, second streaming instances that match the particular streaming context;
setting, by the one or more processors and for each of the identified second streaming instances, the one or more load parameters to the specified second values of the one or more load parameters; and
determining, by the one or more processors, one or more additional performance metrics by monitoring events associated with the identified second streaming instances.

14. The method of claim 13, wherein generating the second slice configuration includes:
generating the second values based on one or both of a stride parameter and a range parameter; or
generating the second values based on the one or more performance metrics.

15. The method of claim 1, wherein:
obtaining the slice configuration includes identifying, using a machine learning model, a cohort of streaming recipients based on one or more expected streaming recipient behaviors; and
generating a value of at least one slice parameter of the one or more slice parameters based on the identified cohort.

16. The method of claim 15, wherein the machine learning model is a clustering model.

17. A system comprising:
one or more processors; and
one or more non-transitory, machine-readable media storing instructions that, when executed by the one or more processors, cause the one or more processors to:
obtain a slice configuration specifying (i) values of one or more slice parameters that define a particular streaming context and (ii) values of one or more load parameters that control supplemental content loads for streaming recipients;
identify, from among a plurality of streaming instances provided by a streaming platform, streaming instances that match the particular streaming context;
set, for each of the identified streaming instances, the one or more load parameters to the specified values of the one or more load parameters; and
determine one or more performance metrics by monitoring events associated with the identified streaming instances.

18. The system of claim 17, wherein:
the one or more processors includes a plurality of processors;
obtaining the slice configuration and identifying the streaming instances that match the particular streaming context are performed by a slice-based load tuning controller implemented by a first subset of the plurality of processors; and
setting the one or more load parameters to the specified values of the one or more load parameters includes the slice-based load tuning controller causing one or more request filters to operate in accordance with the specified values for the streaming instances that match the particular streaming context, the one or more request filters being collectively implemented by a second subset of the plurality of processors.

19. The system of claim 18, wherein identifying the streaming instances that match the particular streaming context includes receiving streaming context data from one or both of:
a plurality of user devices associated with the plurality of streaming instances; and
the streaming platform.

20. The system of claim 18, wherein one or more supplemental content selection servers collectively include a third subset of the plurality of processors, and wherein the instructions cause the third subset of the plurality of processors to:
receive, from the slice-based load tuning controller, the values of the one or more load parameters; and
select supplemental content based in part on the values of the one or more load parameters.
